(19) United States
(12) Patent Application Publication
(10) Pub. No.: US 2018/0054286 A1
(43) Pub. Date: Feb. 22, 2018

(54) POSITIONING REFERENCE SYSTEM (PRS) DESIGN ENHANCEMENT

(71) Applicant: Intel IP Corporation, Santa Clara, CA (US)

(72) Inventors: Yang Tang, Pleasanton, CA (US); Rui Huang, Beijing (CN); Seunghee Han, San Jose, CA (US); Shafi Bashar, Santa Clara, CA (US); Hujun Yin, Saratoga, CA (US)

(21) Appl. No.: 15/552,588

(22) PCT Filed: Dec. 18, 2015
(86) PCT No.: PCT/US15/66740

§ 371 Date: Aug. 22, 2017

Related U.S. Application Data
(60) Provisional application No. 62/144,779, filed on Apr. 8, 2015.

(51) Int. Cl. H04L 5/00; H04L 1/06; H04B 7/0456; G01S 5/10

(52) U.S. Cl. CPC H04L 5/0048; G01S 5/10; H04B 7/0456; H04L 1/0625

(57) ABSTRACT

Techniques for improving observed time difference of arrival (OTDOA) positioning are discussed. One example apparatus employable in an eNB comprises a processor, transmitter circuitry, and receiver circuitry. The processor is configured to: generate a set of positioning reference signals (PRSs); and encode the set of PRSs for a multi-antenna transmission. The transmitter circuitry is configured to transmit the set of PRSs via the multi-antenna transmission. The receiver circuitry is configured to receive a set of reference signal time differences (RSTDs) from a user equipment (UE) in response to the set of PRSs. The processor is further configured to estimate a position of the UE based at least in part on the set of RSTDs.

### REFERENCE TO RELATED APPLICATIONS

This application claims the benefit of U.S. Provisional Application No. 62/144,779 filed Apr. 8, 2015, entitled “ON PRS ENHANCEMENT”, the contents of which are herein incorporated by reference in their entirety.

### FIELD

The present disclosure relates to wireless technology, and more specifically to techniques for improving positioning via observed time difference of arrival (OTDOA techniques through multi-antenna transmission of positioning reference signals (PRSs).

### BACKGROUND

Observed Time Difference Of Arrival (OTDOA) is a downlink positioning method in LTE. OTDOA is a multilateration method in which a UE (user equipment) measures the time of arrival (TOA) of signals received from multiple base stations (Evolved Node Bs (eNBs)) and computes a reference signal time difference (RSTD) that is reported to the network. 3GPP (the Third Generation Partnership Project) defines OTDOA by using the Positioning Reference Signal (PRS).

Indoor UEs will experience more pathloss than outdoor UEs when eNBs are located outdoors. Thus, the number of detectable cells can be reduced for an indoor UE, as a result of the lower SINR (Signal to Interference-plus-Noise Ratio). Indoor positioning is currently being studied by 3GPP RAN (Radio Access Network) WG1 (working group 1) for Rel-13 (Release 13 of the 3GPP specification).

In 3GPP TS (technical specification) 36.133, describing E-UTRAN (evolved universal terrestrial RAN) OTDOA RSTD measurements, the UE physical layer can be capable of reporting RSTD for the reference cell with (PRS SINR)>=−6 dB and all the neighbor cells with (PRS SINR)>=−13 dB. These SINRs were set based on considerations involving outdoor UEs. For indoor UEs, the SINRs can be more stringent due to the signal having to penetrate the building. Details related to PRS are discussed in 3GPP TS 36.211.

### BRIEF DESCRIPTION OF THE DRAWINGS

FIG. 1 is a block diagram illustrating an example user equipment (UE) useable in connection with various aspects described herein.

FIG. 2 is a block diagram illustrating a system that facilitates improved OTDOA performance via multi-antenna transmission of PRS according to various aspects described herein.

FIG. 3 is a block diagram illustrating a system that facilitates improved RSTD measurement based on a multi-antenna transmission of PRSs according to various aspects described herein.

FIG. 4 is a flow diagram illustrating a method that facilitates improved OTDOA performance via multi-antenna transmission of PRS according to various aspects described herein.

FIG. 5 is a flow diagram illustrating a method that facilitates improved RSTD measurement based on a multi-antenna transmission of PRSs according to various aspects described herein.

FIG. 6 is four physical resource block (PRB) diagrams illustrating PRS mappings in single-antenna transmissions for normal cyclic prefix (CP) and extended CP.

FIG. 7 is a pair of PRB diagrams illustrating an example mapping of PRSs for the case with q=2, and nₛ mod 2=1 according to various aspects described here.

FIG. 8 is a pair of PRB diagrams illustrating an example mapping of PRSs for an embodiment employing a hybrid of STBC and SFBC according to various aspects described here.

FIG. 9 is a pair of PRB diagrams illustrating an example mapping of PRSs for an embodiment employing coordinated beamforming with two distinct subsets of PRSs according to various aspects described here.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

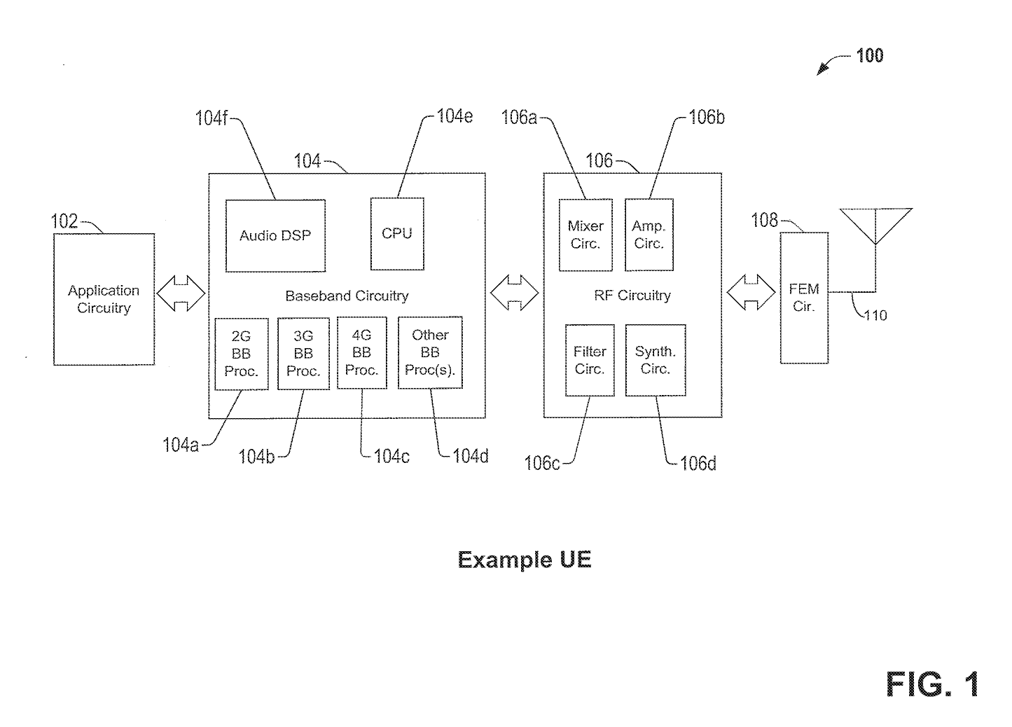

Embodiments described herein may be implemented into a system using any suitably configured hardware and/or software. FIG. 1 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory/storage, display, camera, sensor, and/or input/output (I/O) interface.

In various aspects, techniques can be employed to improve RSTD performance via multi-antenna transmissions. In one set of embodiments, PRS can be precoded and sent via transmit diversity. In another set of embodiments, PRS can be precoded and sent via coordinated beamforming. By transmitting PRS as a multi-antenna transmission, the signal strength can be enhanced, and the interference level can be reduced. Various embodiments described herein can provide better positioning performance than conventional OTDOA positioning techniques via enhanced RSTD measurement performance.

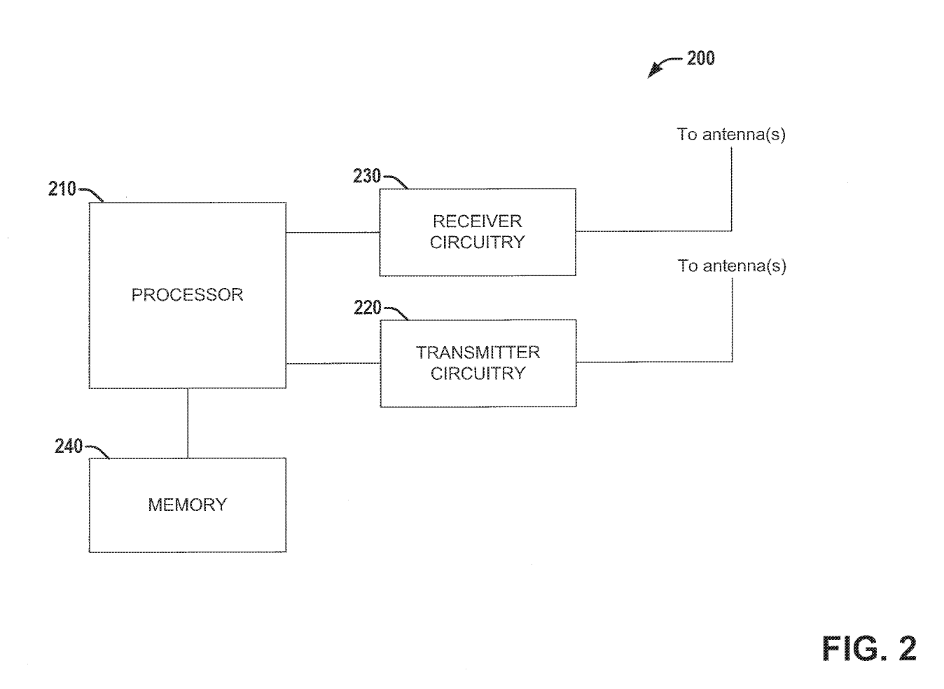

Referring to FIG. 2, illustrated is a block diagram of a system 200 that facilitates improved OTDOA performance via multi-antenna transmission of PRS according to various aspects described herein. System 200 can include a processor 210, transmitter circuitry 220, receiver circuitry 230, and memory 240 (which can comprise any of a variety of storage mediums and can store instructions and/or data associated with one or more of processor 210, transmitter circuitry 220, or receiver circuitry 230). In various aspects, system 200 can be included within an Evolved Universal Terrestrial Radio Access Network (E-UTRAN) Node B (Evolved Node B, eNodeB, or eNB) or other base station in a wireless communications network. As described in greater detail below, system 200 can facilitate transmission of PRSs via either transmit diversity or coordinated beamforming in various aspects.

Processor 210 can generate a set of positioning reference signals (PRSs), such as based on example reference signal sequences described in greater detail below, which can be initialized based on an initialization seed such as the example initialization seed discussed herein (e.g., which can depend on one or more of a slot number, an orthogonal frequency division multiplexing (OFDM) symbol number, a cell identity associated with the eNB employing system 200, or a cyclic prefix (CP) length). Processor 210 can encode the set of PRSs to the physical layer for transmission. In various aspects, processor 210 can select a multi-antenna transmission mode, and, in encoding the set of PRSs, processor 210 can pre-code the set of PRSs for any of a variety of multi-antenna transmission modes (e.g., pre-coded for transmit diversity (e.g., based on a generic Alamouti code, etc.), pre-coded for beamforming via multiple beamforming vectors, etc.). The PRSs can be mapped to specific resource elements (REs) that can depend on the type of multi-antenna transmission (e.g., transmit diversity vs. beamforming), and how the multi-antenna transmission is configured (e.g., normal cyclic prefix (CP) or extended CP, space-time block coding (STBC) and/or space-frequency block coding (SFBC) for transmit diversity, number of beams for transmit diversity, etc.).

For embodiments employing beamforming, the set of PRSs can comprise two or more subsets that are each pre-coded with a distinct beamforming vector. In some embodiments, up to six distinct beamforming vectors can be employed for beamforming transmissions of the set of PRSs.

For embodiments employing transmit diversity, STBC can be employed, SFBC can be employed, or a combination of STBC and SFBC can be employed (e.g., on a symbol-by-symbol basis, etc., with SFBC applying to PRSs transmitted via a first set of OFDM symbols in a subframe, and STBC applying to PRSs transmitted via a distinct second set of OFDM symbols in the subframe).

Transmitter circuitry 220 can transmit the set of PRSs via a plurality of antennas according to the selected multi-antenna transmission mode. Additionally, transmitter circuitry 220 can transmit one or more configuration messages to configure UEs for receiving the PRSs transmitted via the multi-antenna transmission, such as a transmission mode, a bandwidth (e.g., in terms of a number of resource blocks, etc.) for the PRSs, etc.

Receiver circuitry can receive a set of received signal time differences (RSTDs) from one or more UEs. These RSTDs can be measured by UEs as follows. A UE can receive at least a portion of the transmitted set of PRSs, and additional PRSs can be received from one or more other eNBs. Based on the PRSs received from each eNB, the UE can determine time of arrivals (TOAs) of the PRSs, and measure a RSTD associated with that eNB. In aspects, the UE can measure all detectable PRSs, and the eventual RSTD can be determined based on the PRS set(s) with the strongest PRS SINR (signal to interference-plus-noise ratio) and/or the shortest TOA.

After the set of RSTDs has been received, processor 210 can estimate the position of a UE based on the set of RSTDs received from that UE and known positions of the eNBs associated with those RSTDs.

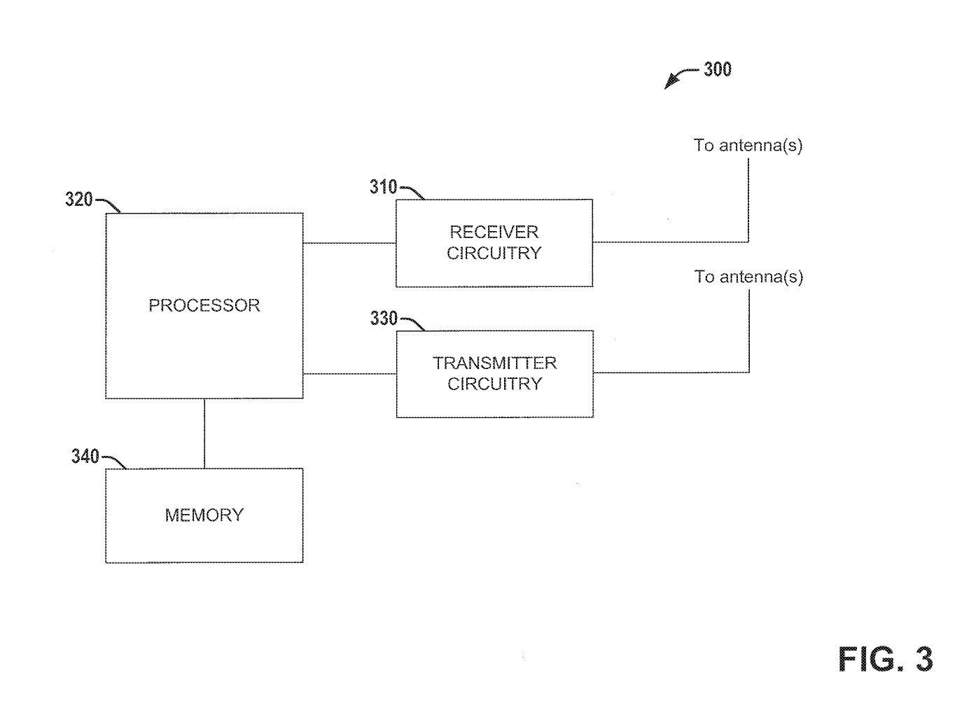

Referring to FIG. 3, illustrated is a block diagram of a system 300 that facilitates improved RSTD measurement based on a multi-antenna transmission of PRSs according to various aspects described herein. System 300 can include receiver circuitry 310, a processor 320, transmitter circuitry 330, and a memory 340 (which can comprise any of a variety of storage mediums and can store instructions and/or data associated with one or more of receiver circuitry 310, processor 320, or transmitter circuitry 330). In various aspects, system 300 can be included within a user equipment (UE). As described in greater detail below, system 300 can improve RSTD measurement accuracy via calculations based on a received multi-antenna transmission of PRSs.

Receiver circuitry 310 can receive a set of PRSs from each of one or more eNBs. In various embodiments, at least one of the received sets of PRSs can be a set of PRSs transmitted via a multi-antenna transmission, such as via transmit diversity or coordinated beamforming (other received sets of PRSs can be transmitted via either conventional techniques or also via multi-antenna transmissions such as those described herein). In some embodiments, one or more combining techniques can be applied to some or all of the sets of PRSs received via the multi-antenna transmission of PRSs (e.g., diversity combining, etc.), which can depend on one or more of the type of multi-antenna transmission (e.g., diversity, beamforming, etc.), configuration of that transmission, etc.

Processor 320 can determine a TOA for each received PRS, which can be based on combining in connection with PRSs received via multi-antenna transmissions. Based on the set of PRSs received from each eNB, processor 320 can measure a RSTD associated with that eNB.

Transmitter circuitry 330 can transmit the set of measured RSTDs to a serving eNB.

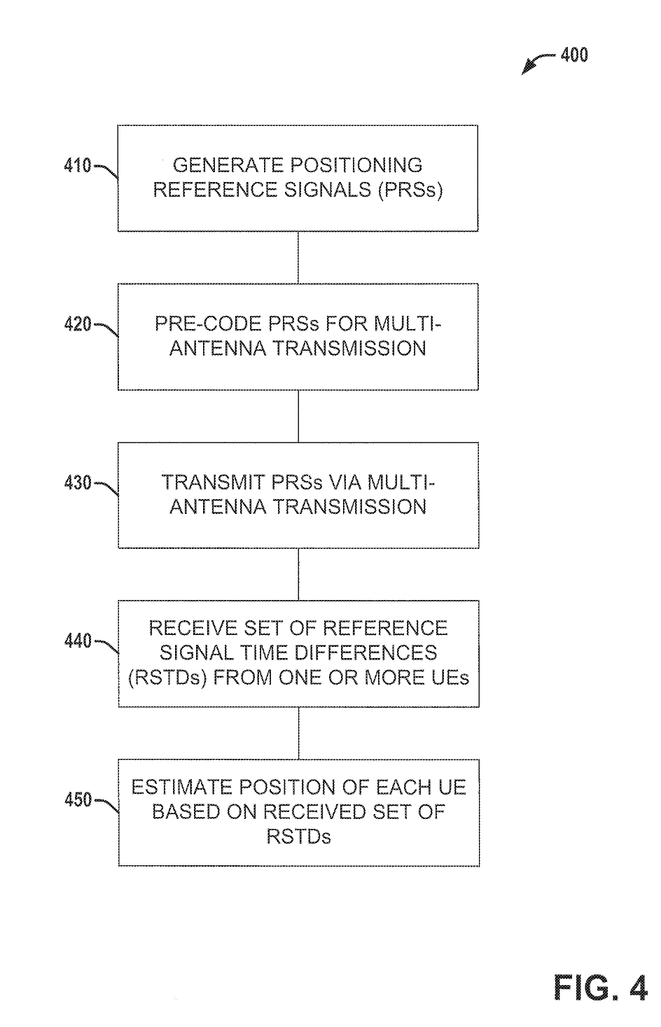

Referring to FIG. 4, illustrated is a flow diagram of a method 400 that facilitates improved OTDOA performance via multi-antenna transmission of PRS according to various aspects described herein. In some aspects, method 400 can be performed at an eNB. In other aspects, a machine readable medium can store instructions associated with method 400 that, when executed, can cause an eNB to perform the acts of method 400.

At 410, a set of PRSs can be generated.

At 420, the set of PRSs can be encoded for transmission, which can comprise pre-coding the PRSs for a multi-antenna transmission (e.g., transmit diversity, coordinated beamforming, etc.).

At 430, the set of PRSs can be transmitted via a specific set of resource elements.

At 440, a set of RSTDs can be received from each of one or more UEs.

At 450, based on the received set of RSTDs from a UE and known positions of eNBs associated with those RSTDs, the position of that UE can be estimated.

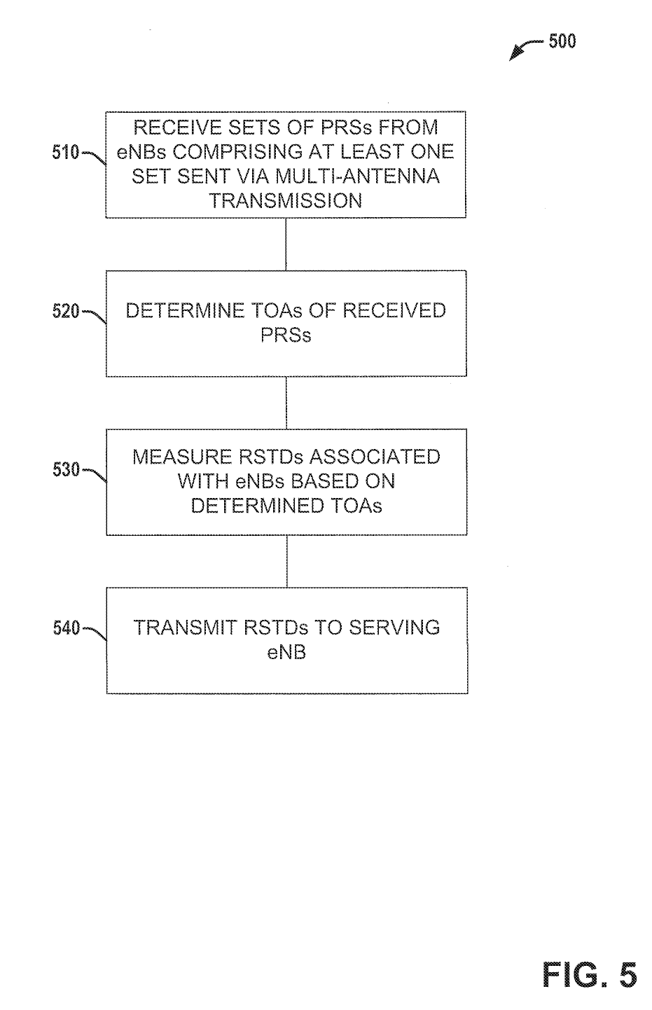

Referring to FIG. 5, illustrated is a flow diagram of a method 500 that facilitates improved RSTD measurement based on a multi-antenna transmission of PRSs according to various aspects described herein. In some aspects, method 500 can be performed at a UE. In other aspects, a machine readable medium can store instructions associated with method 500 that, when executed, can cause a UE to perform the acts of method 500.

At 510, a set of PRSs can be received from each of one or more eNBs, with at least one of the sets of PRSs comprising a set of PRSs transmitted via a multi-antenna transmission (e.g., diversity transmission, coordinated beamforming, etc.).

At 520, a TOA can be determined for each received PRS, which, in various aspects, can be based on combining of PRSs received via multi-antenna transmissions.

At 530, an RSTD can be measured for each eNB based on the TOAs determined for the PRSs received from that eNB.

At 540, the measured RSTDs can be transmitted to a serving eNB associated with the UE implementing method 500.

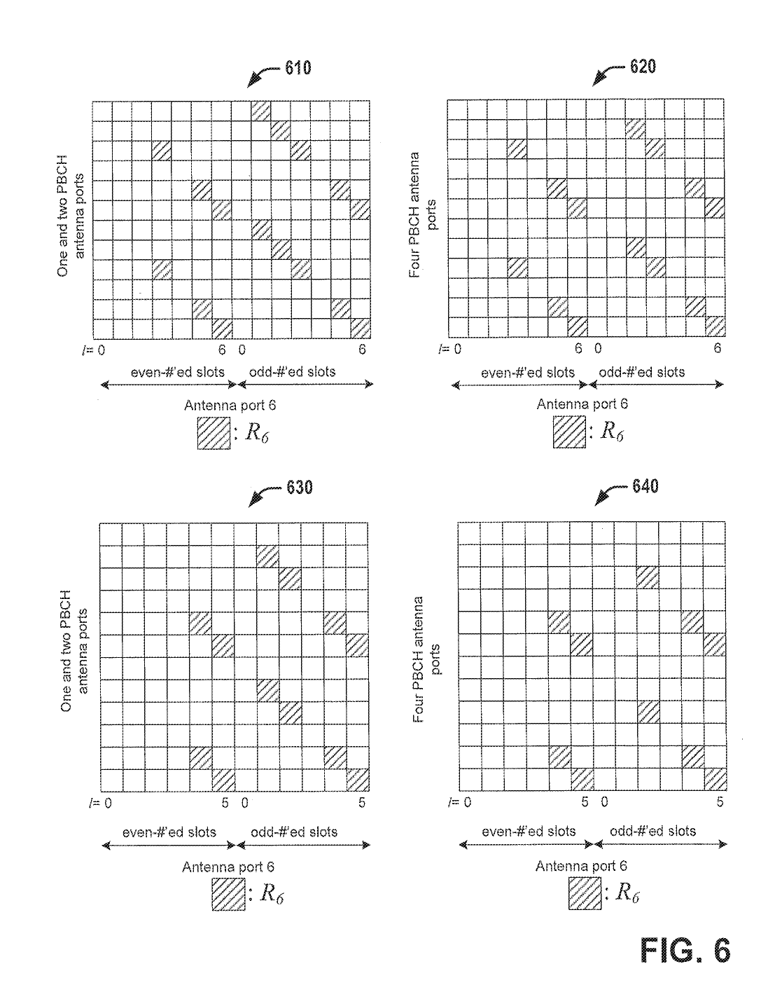

Referring to FIG. 6, illustrated are physical resource block (PRB) diagrams showing PRS mappings in single-antenna transmissions for normal CP (at 610 and 620) and extended CP (at 630 and 640). In various aspects, PRSs transmitted via multi-antenna transmissions can be mapped to REs based at least in part on the PRS mapping for single-antenna transmissions.

Various embodiments disclosed herein can employ multi-antenna transmission techniques (e.g., diversity transmission, coordinated beamforming, etc.) to transmit PRSs, or can receive PRSs transmitted via a multi-antenna transmission technique and determine an RSTD based on those PRSs. A first set of embodiments can employ transmit diversity techniques, and a second set of embodiments can employ coordinated beamforming techniques.

In the first set of embodiments, the PRS can be precoded for transmit diversity via pre-coding with STBC, SFBC, or a combination of STBC and SFBC.

As an example of the first set of embodiments, SFBC can be employed to precode PRS (STBC can be similarly employed, with corresponding changes). The reference signal sequences r_{l,n}_{ₛ}_{,AP0}(m) and r_{l,n}_{ₛ}_{,AP1}(m) can be defined by

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , 1 , … , q \cdot {N}_{RB}^{max , DL} - 1 \qquad ( 1 )$$

where nₛ is the slot number within a radio frame, l is the OFDM symbol number within that slot, q is the number of PRSs per 12 REs, and AP0 and AP1 are the indices of the transmit antenna ports. The pseudo-random sequence c(i) can be defined as in section 7.2 of 3GPP TS 36.211, and can be initialized with

cᵢₙᵢₜ=2¹⁰·(7·(nₛ+1)+l+1)·(2·N_{ID}^{cell}+1)+2·N_{ID}^{cell}+N_{CP} (2)

at the start of each OFDM symbol, where N_{CP} can be 1 for normal CP and 0 for extended CP.

The reference signal sequences r_{l,n}_{ₛ}_{,AP0}(m) and r_{l,n}_{ₛ}_{,AP1}(m) can be mapped to the complex-valued modulation symbols (a_{k,l,AP0}^{(p)}, a_{k,l,AP0}^{(p)}) and (a_{k+1,l,AP0}^{(p)}, a_{k+1,l,AP0}^{(p)}) can be used as reference signals for antenna port p=6 in slot nₛ according to

a_{k,l,AP0}^{(p)}=r_{l,n}_{ₛ}_{,AP0}(m′)

a_{k,l,AP1}^{(p)}=r_{l,n}_{ₛ}_{,AP1}(m′)

a_{k-1,l,AP0}^{(p)}=r_{l,n}_{ₛ}_{,AP1}(m′)*

a_{k+1,l,AP0}^{(p)}=−r_{l,n}_{ₛ}_{,AP0}(m′)* (3)

where for Normal CP,

$$k = 12 / q \cdot ( m + {N}_{RB}^{DL} - {N}_{RB}^{PRS} ) + ( 12 / q - l + {v}_{shift} ) mod ( 12 / q ) \\ l = \{ \begin{matrix}3 , 5 , 6 & if {n}_{s} mod 2 = 0 \\ 1 , 2 , 3 , 5 , 6 & if {n}_{s} mod 2 = 1 and ( \begin{matrix}1 or 2 PBCH \\ antenna ports\end{matrix} ) \\ 2 , 3 , 5 , & if {n}_{s} mod 2 = 1 and ( \begin{matrix}4 PBCH \\ antenna ports\end{matrix} )\end{matrix} \\ m = 0 , 1 , K , 2 \cdot {N}_{RB}^{PRS} - 1 \\ {m}^{′} = m + {N}_{RB}^{max , DL} - {N}_{RB}^{PRS} \qquad ( 4 )$$

and for extended CP,

$$k = 6 ( m + {N}_{RB}^{DL} - {N}_{RB}^{PRS} ) + ( 5 - l + {v}_{shift} ) mod 6 \\ l = \{ \begin{matrix}4 , 5 & if {n}_{s} mod 2 = 0 \\ 1 , 2 , 4 , 5 & if {n}_{s} mod 2 = 1 and ( \begin{matrix}1 or 2 PBCH \\ antenna ports\end{matrix} ) \\ 2 , 4 , 5 , & if {n}_{s} mod 2 = 1 and ( \begin{matrix}4 PBCH \\ antenna ports\end{matrix} )\end{matrix} \\ m = 0 , 1 , K , q \cdot {N}_{RB}^{PRS} - 1 \\ {m}^{′} = m + {N}_{RB}^{max , DL} - {N}_{RB}^{PRS} \qquad ( 5 )$$

To take advantage of the SFBC structure, k can be defined as

k=12/q·(m+N_{RB}^{DL}−N_{RB}^{PRS})+2·(12/q−1+ν_{shift})mod(12/q) (6)

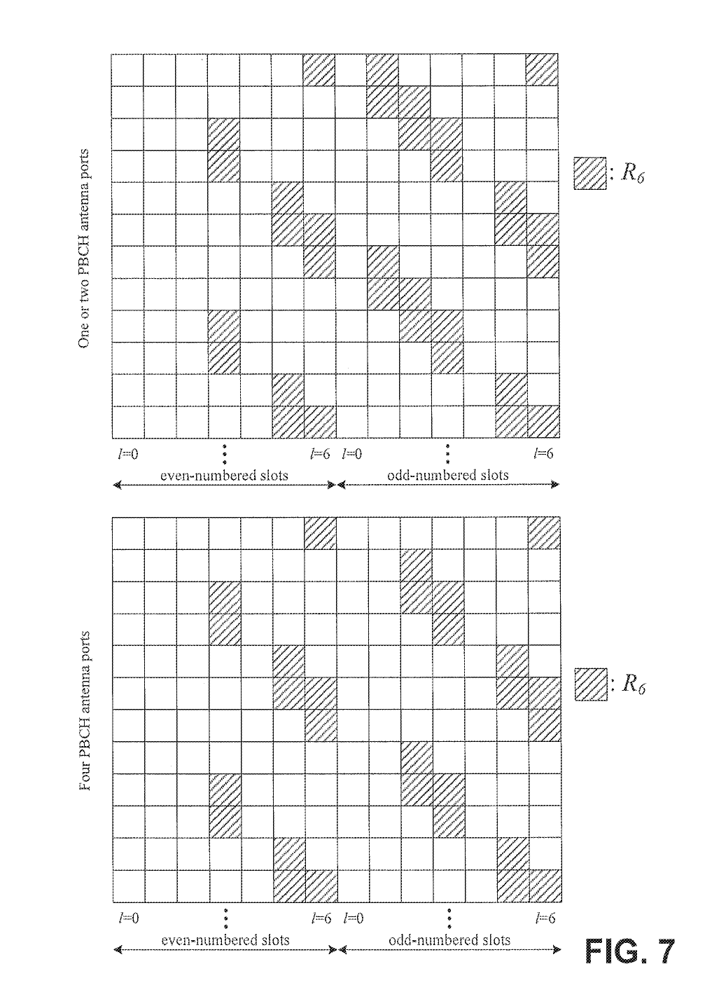

The bandwidth for PRSs (N_{RB}^{PRS}) can be configured by higher layers, and the cell-specific frequency shift (ν_{shift}) can be given by ν_{shift}=N_{ID}^{cell} mod (12/q), where 12/q is an integer with a minimum value of 12/q=2. Referring to FIG. 7, illustrated is an example mapping of PRSs for the case with q=2, and nₛ mod 2=1 according to various aspects described here.

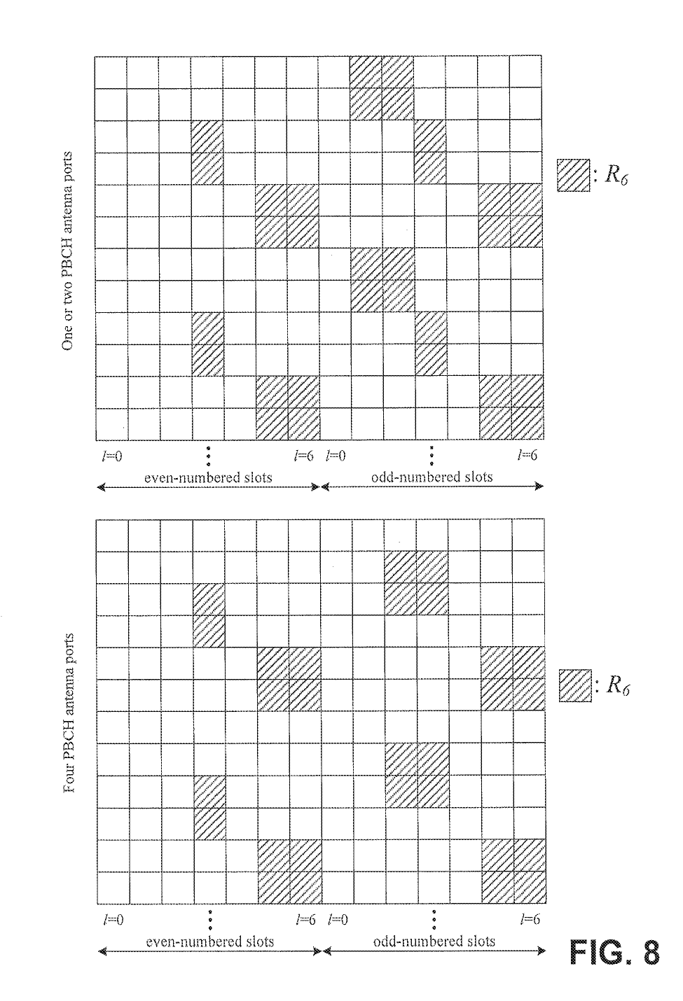

In another example from the first set of embodiments, a hybrid of STBC and SFBC can be applied for pre-coding the PRSs. In various aspects, STBC or SFBC can apply depending on the index of the OFDM symbol. Referring to FIG. 8, illustrated is an example mapping of PRSs for an embodiment employing a hybrid of STBC and SFBC according to various aspects described here.

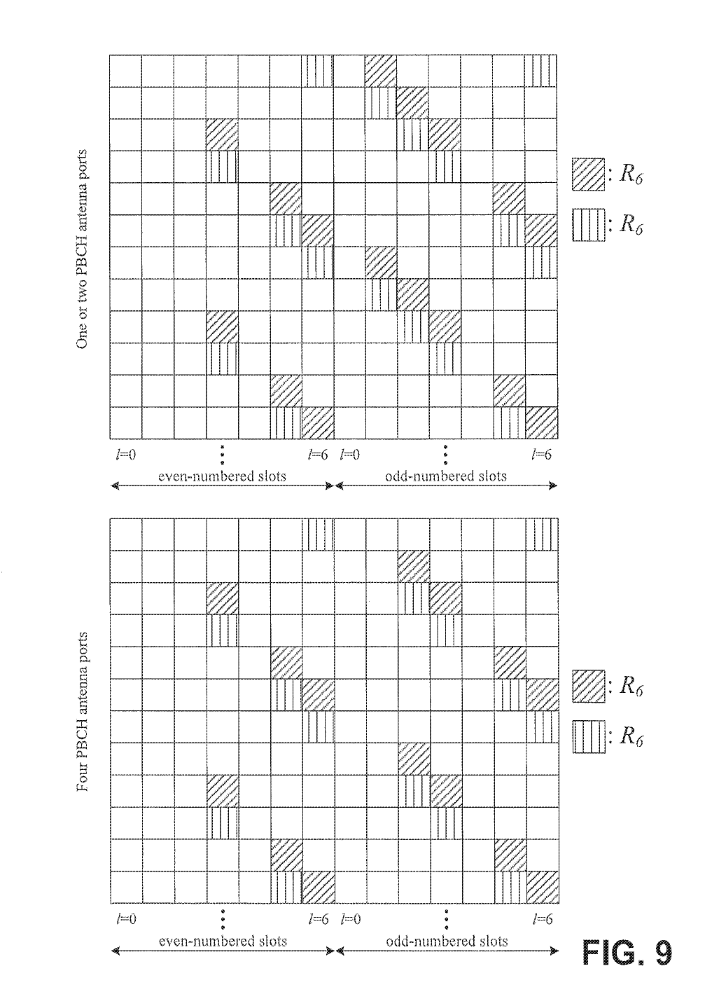

In the second set of embodiments, PRSs can be precoded for coordinated beamforming. Transmitted PRSs can be classified into multiple subsets, with each PRS in a given subset precoded with a distinct beamforming vector associated with that subset. Thus, different subsets of PRSs can be precoded with different beamforming vectors, and each PRSs within a subset can be precoded with a common beamforming vector for that subset. In the second set of embodiments, the pre-selected beamforming vectors from different eNBs can be coordinated to that inter-cell interference (ICI) can be reduced. Referring to FIG. 9, illustrated is an example mapping of PRSs for an embodiment employing coordinated beamforming with two distinct subsets of PRSs according to various aspects described here. In FIG. 9, each subset of PRSs has shading that is common to that subset, and can be pre-coded with a predetermined beamforming vector associated with that subset. In various aspects, up to 6 distinct subsets of PRSs can be configured for beamforming. A first subset of PRSs can be mapped to REs corresponding to the single antenna mapping of PRSs illustrated in FIG. 6 (as shown with the subset having lighter shading), and additional subsets can be mapped to REs in adjacent subcarriers to PRSs of the first subset (as shown with the subset having darker shading). Although a normal CP example is illustrated in FIG. 9, extended CP embodiments can be similarly constructed.

Examples herein can include subject matter such as a method, means for performing acts or blocks of the method, at least one machine-readable medium including executable instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to embodiments and examples described.

Example 1 is an apparatus configured to be employed within an evolved Node B (eNB), comprising a processor, transmitter circuitry, and receiver circuitry. The processor is configured to: generate a set of positioning reference signals (PRSs); and encode the set of PRSs for a multi-antenna transmission. The transmitter circuitry is configured to transmit the set of PRSs via the multi-antenna transmission. The receiver circuitry is configured to receive a set of reference signal time differences (RSTDs) from a user equipment (UE) in response to the set of PRSs. The processor is further configured to estimate a position of the UE based at least in part on the set of RSTDs.

Example 2 comprises the subject matter of example 1, wherein the multi-antenna transmission employs transmit diversity.

Example 3 comprises the subject matter of example 2, wherein the processor is configured to encode the set of PRSs at least in part by pre-coding the set of PRSs via a space-time block coding (STBC).

Example 4 comprises the subject matter of example 2, wherein the processor is configured to encode the set of PRSs at least in part by pre-coding the set of PRSs via a space-frequency block coding (SFBC).

Example 5 comprises the subject matter of any of examples 2-4, including or omitting optional features, wherein the set of PRSs are based at least in part on a pseudo-random sequence initialized with a seed that depends at least in part on one or more of a slot number, an orthogonal frequency division multiplexing (OFDM) symbol number, a cell ID associated with the eNB, or a cyclic prefix (CP) length.

Example 6 comprises the subject matter of example 1, wherein the processor is configured to encode the set of PRSs at least in part by pre-coding a first subset of the set of PRSs via a space-time block coding (STBC) and pre-coding a second subset of the set of PRSs via a space-frequency block coding (SFBC), and wherein the transmitter circuitry is configured to transmit the first subset via a first set of orthogonal frequency division multiplexing (OFDM) symbols and to transmit the second subset via a distinct second set of OFDM symbols.

Example 7 comprises the subject matter of example 1, wherein the multi-antenna transmission employs coordinated beamforming.

Example 8 comprises the subject matter of example 7, wherein the set of PRSs comprises a plurality of subsets of PRSs, wherein each of the plurality of subsets is associated with a distinct beamforming vector, wherein the processor is configured to encode the set of PRSs at least in precode each PRS of the set of PRSs with the distinct beamforming vector associated with the subset that comprises that PRS.

Example 9 comprises the subject matter of example 8, wherein the plurality of subsets comprises six or fewer subsets.

Example 10 comprises the subject matter of example 2, wherein the set of PRSs are based at least in part on a pseudo-random sequence initialized with a seed that depends at least in part on one or more of a slot number, an orthogonal frequency division multiplexing (OFDM) symbol number, a cell ID associated with the eNB, or a cyclic prefix (CP) length.

Example 11 is a machine readable medium comprising instructions that, when executed, cause an evolved Node B (eNB) to: construct a plurality of positioning reference signals (PRSs); pre-code the plurality of PRSs for a multi-antenna transmission mode; and transmit the plurality of PRSs to a user equipment (UE) via the multi-antenna transmission mode.

Example 12 comprises the subject matter of example 11, wherein the multi-antenna transmission mode comprises transmit diversity.

Example 13 comprises the subject matter of example 12, wherein the plurality of PRSs are pre-coded via at least one of a space-time block coding (STBC) or a space-frequency block coding (SFBC).

Example 14 comprises the subject matter of example 13, wherein the plurality of PRSs comprises a first set of PRSs pre-coded via the pre-coded via the STBC and a second set of PRSs pre-coded via the SFBC, wherein the first set of PRSs is transmitted via a first set of orthogonal frequency division multiplexing (OFDM) symbols, and wherein the second set of PRSs is transmitted via a non-overlapping second set of orthogonal frequency division multiplexing (OFDM) symbols.

Example 15 comprises the subject matter of example 12, wherein the plurality of PRSs are pre-coded based on a generic Alamouti code.

Example 16 comprises the subject matter of example 11, wherein the multi-antenna transmission mode comprises beamforming.

Example 17 comprises the subject matter of example 16, wherein the plurality of PRSs comprises two or more sets of PRSs, wherein each of the two or more sets are pre-coded with a distinct beamforming vector.

Example 18 comprises the subject matter of any of examples 11-17, including or omitting optional features, wherein the instructions, when executed, further cause the eNB to transmit one or more configuration messages that configure the UE based on the multi-transmission mode.

Example 19 comprises the subject matter of any variation of example 18, wherein the one or more configuration messages configure a bandwidth associated with the plurality of PRSs.

Example 20 comprises the subject matter of example 11, wherein the instructions, when executed, further cause the eNB to transmit one or more configuration messages that configure the UE based on the multi-transmission mode.

Example 21 is an apparatus configured to be employed within a user equipment (UE), comprising receiver circuitry, a processor, and transmitter circuitry. The receiver circuitry is configured to receive a first set of positioning reference signals (PRSs) from a first evolved Node B (eNB) via a multi-antenna transmission, and to receive one or more additional sets of PRSs from one or more additional eNBs. The a processor is configured to: determine a time of arrival (TOA) of one or more PRSs of the first set of PRSs; determine a TOA of one or more PRSs of each of the one or more additional sets of PRSs; compute a first reference signal time difference (RSTD) based at least in part on the TOAs of the one or more PRSs of the first set, and one or more additional RSTDs based at least in part on the one or more PRSs of each of the one or more additional sets. The transmitter circuitry is configured to transmit the computed first RSTD and the one or more additional RSTDs.

Example 22 comprises the subject matter of example 21, wherein the multi-antenna transmission is a transmit diversity transmission.

Example 23 comprises the subject matter of example 22, wherein one or more PRSs of the first set of PRSs are pre-coded via a space-time block coding (STBC).

Example 24 comprises the subject matter of example 22, wherein one or more PRSs of the first set of PRSs are pre-coded via a space-frequency block coding (SFBC).

Example 25 comprises the subject matter of example 21, wherein the multi-antenna transmission is a coordinated beamforming transmission.

Example 26 comprises the subject matter of example 25, wherein the first set of PRSs comprises two or more subsets of PRSs, wherein each subset is associated with a distinct beamforming vector, and wherein each PRS is pre-coded based at least in part on the distinct beamforming vector associated with the subset comprising that PRS.

Example 27 comprises the subject matter of example 21, wherein the processor is a baseband processor.

Example 28 is an apparatus configured to be employed within an evolved Node B (eNB), comprising means for processing, means for transmitting, and means for receiving. The means for processing is configured to: generate a set of positioning reference signals (PRSs); and encode the set of PRSs for a multi-antenna transmission. The means for transmitting is configured to transmit the set of PRSs via the multi-antenna transmission. The means for receiving configured to receive a set of reference signal time differences (RSTDs) from a user equipment (UE) in response to the set of PRSs. The means for processing is further configured to estimate a position of the UE based at least in part on the set of RSTDs.

Example 29 is an apparatus configured to be employed within a user equipment (UE), comprising means for receiving, means for processing, and means for transmitting. The means for receiving is configured to receive a first set of positioning reference signals (PRSs) from a first evolved Node B (eNB) via a multi-antenna transmission, and to receive one or more additional sets of PRSs from one or more additional eNBs. The means for processing is configured to: determine a time of arrival (TOA) of one or more PRSs of the first set of PRSs; determine a TOA of one or more PRSs of each of the one or more additional sets of PRSs; and compute a first reference signal time difference (RSTD) based at least in part on the TOAs of the one or more PRSs of the first set, and one or more additional RSTDs based at least in part on the one or more PRSs of each of the one or more additional sets. The means for transmitting is configured to transmit the computed first RSTD and the one or more additional RSTDs.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

1. An apparatus configured to be employed within an evolved Node B (eNB), comprising:
a processor configured to:
generate a set of positioning reference signals (PRSs); and
encode the set of PRSs for a multi-antenna transmission;
transmitter circuitry configured to transmit the set of PRSs via the multi-antenna transmission; and
receiver circuitry configured to receive a set of reference signal time differences (RSTDs) from a user equipment (UE) in response to the set of PRSs,
wherein the processor is further configured to estimate a position of the UE based at least in part on the set of RSTDs.

2. The apparatus of claim 1, wherein the multi-antenna transmission employs transmit diversity.

3. The apparatus of claim 2, wherein the processor is configured to encode the set of PRSs at least in part by pre-coding the set of PRSs via a space-time block coding (STBC).

4. The apparatus of claim 2, wherein the processor is configured to encode the set of PRSs at least in part by pre-coding the set of PRSs via a space-frequency block coding (SFBC).

5. The apparatus of claim 2, wherein the set of PRSs are based at least in part on a pseudo-random sequence initialized with a seed that depends at least in part on one or more of a slot number, an orthogonal frequency division multiplexing (OFDM) symbol number, a cell ID associated with the eNB, or a cyclic prefix (CP) length.

6. The apparatus of claim 1, wherein the processor is configured to encode the set of PRSs at least in part by pre-coding a first subset of the set of PRSs via a space-time block coding (STBC) and pre-coding a second subset of the set of PRSs via a space-frequency block coding (SFBC), and wherein the transmitter circuitry is configured to transmit the first subset via a first set of orthogonal frequency division multiplexing (OFDM) symbols and to transmit the second subset via a distinct second set of OFDM symbols.

7. The apparatus of claim 1, wherein the multi-antenna transmission employs coordinated beamforming.

8. The apparatus of claim 7, wherein the set of PRSs comprises a plurality of subsets of PRSs, wherein each of the plurality of subsets is associated with a distinct beamforming vector, wherein the processor is configured to encode the set of PRSs at least in precode each PRS of the set of PRSs with the distinct beamforming vector associated with the subset that comprises that PRS.

9. The apparatus of claim 8, wherein the plurality of subsets comprises six or fewer subsets.

10. A non-transitory machine readable medium comprising instructions that, when executed, cause an evolved Node B (eNB) to:
construct a plurality of positioning reference signals (PRSs);
pre-code the plurality of PRSs for a multi-antenna transmission mode; and
transmit the plurality of PRSs to a user equipment (UE) via the multi-antenna transmission mode.

11. The non-transitory machine readable medium of claim 10, wherein the multi-antenna transmission mode comprises transmit diversity.

12. The non-transitory machine readable medium of claim 11, wherein the plurality of PRSs are pre-coded via at least one of a space-time block coding (STBC) or a space-frequency block coding (SFBC).

13. The non-transitory machine readable medium of claim 12, wherein the plurality of PRSs comprises a first set of PRSs pre-coded via the pre-coded via the STBC and a second set of PRSs pre-coded via the SFBC, wherein the first set of PRSs is transmitted via a first set of orthogonal frequency division multiplexing (OFDM) symbols, and wherein the second set of PRSs is transmitted via a non-overlapping second set of orthogonal frequency division multiplexing (OFDM) symbols.

14. The non-transitory machine readable medium of claim 11, wherein the plurality of PRSs are pre-coded based on a generic Alamouti code.

15. The non-transitory machine readable medium of claim 10, wherein the multi-antenna transmission mode comprises beamforming.

16. The non-transitory machine readable medium of claim 15, wherein the plurality of PRSs comprises two or more sets of PRSs, wherein each of the two or more sets are pre-coded with a distinct beamforming vector.

17. The non-transitory machine readable medium of claim 10, wherein the instructions, when executed, further cause the eNB to transmit one or more configuration messages that configure the UE based on the multi-transmission mode.

18. The non-transitory machine readable medium of claim 17, wherein the one or more configuration messages configure a bandwidth associated with the plurality of PRSs.

19. An apparatus configured to be employed within a user equipment (UE), comprising:
receiver circuitry configured to receive a first set of positioning reference signals (PRSs) from a first evolved Node B (eNB) via a multi-antenna transmission, and to receive one or more additional sets of PRSs from one or more additional eNBs;
a processor configured to:
determine a time of arrival (TOA) of one or more PRSs of the first set of PRSs;
determine a TOA of one or more PRSs of each of the one or more additional sets of PRSs; and
compute a first reference signal time difference (RSTD) based at least in part on the TOAs of the one or more PRSs of the first set, and one or more additional RSTDs based at least in part on the one or more PRSs of each of the one or more additional sets; and
transmitter circuitry configured to transmit the computed first RSTD and the one or more additional RSTDs.

20. The apparatus of claim 19, wherein the multi-antenna transmission is a transmit diversity transmission.

21. The apparatus of claim 20, wherein one or more PRSs of the first set of PRSs are pre-coded via a space-time block coding (STBC).

22. The apparatus of claim 20, wherein one or more PRSs of the first set of PRSs are pre-coded via a space-frequency block coding (SFBC).

23. The apparatus of claim 19, wherein the multi-antenna transmission is a coordinated beamforming transmission.

24. The apparatus of claim 23, wherein the first set of PRSs comprises two or more subsets of PRSs, wherein each subset is associated with a distinct beamforming vector, and wherein each PRS is pre-coded based at least in part on the distinct beamforming vector associated with the subset comprising that PRS.

25. The apparatus of claim 19, wherein the processor is a baseband processor.
